(19) United States
(12) Patent Application Publication
(10) Pub. No.: US 2007/0094391 A1
(43) Pub. Date: Apr. 26, 2007

(54) FEEDBACK METRICS FOR RSS FEEDS

(76) Inventor: Bill Nussey, Smyrna, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/163,568

(22) Filed: Oct. 23, 2005

(51) Int. Cl. G06F 15/173

(52) U.S. Cl. 709/225

(57) ABSTRACT

Feedback metrics for activity pertaining to an RSS feed and/or and individualized RSS feed are provided by utilizing feedback hooks. One feedback hook includes web beacons placed within portions of the RSS index file and the RSS content files. Another feedback hook includes redirecting links associated with the RSS content to an interim address that corresponds to a reporting system and the redirecting the links to the original destination thereby allowing information about accessing the link to be obtained. In addition, an RSS catcher operates to provide additional feedback information pertaining to the formation, subscription and access of the RSS feed.

### CROSS-REFERENCE TO RELATED APPLICATIONS

This application is related to, and incorporates herein by reference, United States applications for patent entitled:

“GENERAL PURPOSE RSS CATCHER”, filed on Oct. 23, 2005 and assigned Ser. No. 11/163,563, and identified as docket number 19011.1610,

“PROVISION OF SECURE RSS FEEDS UTILIZING A SECURE RSS CATCHER”, filed on Oct. 23, 2005 and assigned Ser. No. 11/163,565, and identified as docket number 19011.1620,

“DELIVERY OF NON-SENSITIVE AND SENSITIVE INFORMATION THROUGH DUAL RECORD RSS”, filed on Oct. 23, 2005 and assigned Ser. No. 11/163,566, and identified as docket number 19011.1630,

“DELIVERY OF SENSITIVE INFORMATION THROUGH SECURE RSS FEED”, filed on Oct. 23, 2005 and assigned Ser. No. 11/163,567, and identified as docket number 19011.1640, and

“PERSONALIZED RSS FEEDS WITH ARCHIVES AND AUTOMATIC CLEANUP”, filed on Oct. 23, 2005 and assigned Ser. No. ______, and identified as docket number 19011.1660.

### BACKGROUND OF THE INVENTION

The present invention is related to the field of RSS based Internet communication, and, more particularly, to the field of obtaining feedback metrics on the usage and activity of customers with RSS feeds.

One of the most valuable and coveted category of information for marketing companies is customer feedback. What is the customer thinking?, what is the customer doing?, what is the customer not doing?, how did the customer react to a particular action?, etc. Marketing organizations need this information to provide relevant and targeted communications for each customer. Otherwise, to some extent the marketing companies are simply shooting in the dark and hoping to hit a target.

Listen. This should be the foremost goal of any marketing organization or marketer. As writer/actor Wilson Mizner coined “a good listener is not only popular everywhere, but after a while he gets to know something”. An effective marketer should spend more time listening to the feedback and reactions of the marketer's communication, than in the communication itself. And it is a smart marketer, who only has to receive once, the treatment of the shrew in Shakespeare's the taming of the Shrew—a cuff “but to knock at your ear, and beseech listening”. Blindly throwing out advertisements, communications, flyers, billboards, commercials, or the like without first taking counsel of the targeted demographics and constructing the communication in accordance with such counseling, is simply wasting time, effort and money—or worse yet, it is SPAM or unwanted telemarketing.

Reams of information have been written about marketing strategies, techniques and psychologies. However, with the advent of the Internet and the ability to push information through the Internet, a entirely new world was opened—Internet marketing. During the dot-com era, the typical pitch from a young man wearing a black, skin-tight, mock turtleneck shirt with a blazer, and sporting a web application that was developed in his garage was “if I only get 10% of the traffic, we are talking about millions of eyeballs on your advertisements”. A lot was learned as a result of the dot-com bust. One lesson was that not many of the young men so suited actually had what it took to be successful. Another lesson was that the philosophy of “if you build it, they will come” only works in Hollywood.

Even today, with as much development and advancements that have been made in Internet technology, marketers are still looking for mechanisms to obtain feedback regarding the advertisements or communications that they push out to Internet users. However, this has been a long standing problem in the industry. Newspaper adds, magazine adds, television adds, radio adds, billboards and painted busses are all mediums used for push, or as marketing guru Seth Godin calls it, “Interruptive” advertising. To obtain marketing feedback, marketers have used techniques such as providing specific offers and offer codes in conjunction with the advertisements. Target recipients are encouraged and motivated to use the offer codes when following up on the advertisement. On example of this technique is the use of redeemable coupons. Other techniques include asking customers at a point-of-sale or when they approach a merchant what motivated their actions. These techniques for obtaining push advertising feedback only focus on the target recipients that are successfully motivated. Short comings of these techniques and other techniques include the reliance on merchants to solicit the information and for the customers to reliably and accurately provide the information. In addition, the only demographic that is polled using these techniques are the successes, the entire domain of target recipients that do not actually respond to an advertisement are unreachable for feedback.

With the advent of email, a huge advancement in the ability to obtain push advertisement feedback was achieved. First of all, rather than relying on projected demographics for other advertising means (i.e., newspapers, magazines, billboards, etc), email is able to achieve a higher degree of granularity in push advertising relevance. By addressing the advertisements on an individual basis (i.e., an email address), marketers are able to more accurately predict and control the target audience. In addition, email provides many very significant analytics that have been used by many marketing companies. The first analytic is confirmation that the email was delivered. Such a capability provides valuable information to the marketer. This information confirms to the marketer that the email address was not only valid, but that the account is up and active and thus, there is a strong possibility that the email actually was received by the targeted individual. In addition, as is well known in the art, an email message can be created such that confirmation that the email was read is available to the marketer. <most users have no idea they are being tracked in email>. Other email analytics include the ability to determine if an individual clicked on a link to go a website or even if the email click resulted in an online purchase at the website. The value of such feedback is enormous for marketing companies in that not only can they confirm that the address is valid and that the email was delivered, they can actually determine many of the actions taken by the recipient. Thus, if an email advertisement is consistently unread, the marketing organization can try different promotion or communication. If an email is consistently read, the marketing organization can further develop and promote the promotions that received positive responses.

Another advancement that has occurred in the ability to obtain advertising and content feedback is in the field of gathering demographic information and analytics from web surfers visiting a website. Most website activity analysis systems will monitor the number of hits that a website receives, as well as the time spent by visitors, where they went and what they did while visiting the site. Other systems prompt the visitor to enter demographic information such as the visitor's age, gender, profession, income range, residence, etc. Some systems even provide user rewards and redeemable points, coupons or potential prizes for entering such information. This information is extremely useful to the marketing companies in analyzing the reactions to the content. However, this technique is only useful for users that actually come to the website and thus, is not applicable to push advertising.

A recent development in the world of Internet communications, and one that is rapidly gaining popularity, is the use of RSS feeds. An RSS feed is basically a mechanism to enable a customer to selectively allow content to be pushed to them. Content is provided through an RSS feed by placing the content on a server in accordance with the RSS standard format. In general, this includes an XML index file that contains various entries identifying available content. For instance, each entry may include a title, a summary or abstract and a link to another file, and HTML or XML content file. The HTML or XML content files actually contain the bulk of the content.

Content available through an RSS feed is obtained using a software client called an RSS reader or aggregator. The RSS feeds are based on an RSS standard and thus, they can easily be read by an RSS feed reader and most RSS feed readers can handle all of the current RSS standards. An RSS reader or aggregator is usually a stand alone program or an integrated part of an online portal like Yahoo! (though it may be integrated with an email program, an internet browser or other communications program) that periodically and automatically searches the Internet for new additions to any site to which the end user has subscribed by examining the XML index files. Some RSS readers will provide a popup window message when new material arrives on a subscribed RSS feed. Some RSS readers will check the RSS feeds for new content on a scheduled basis, while others wait until they are checked or actuated by the end user. Typically, the RSS readers can be customized as to the frequency of site checking and the ways that selected content is displayed. A user can subscribe to as many RSS feeds as they wish. RSS readers generally allow the user to define the manner in which the information is displayed. For instance, the information can be sorted by date and/or by the publisher of the data.

RSS feeds are similar to simply accessing web content through a browser but there is one, very significant difference. With an RSS feed, when any new material is available, the RSS feeds provide a very simple way for RSS readers to see when and what material has changed. RSS feed readers allow you to subscribe to feeds that you know contain important or useful information, and your RSS reader will notify you immediately whenever new content for your subscriptions is available. In short, once you've identified a useful resource that publishes an RSS feed, you can virtually skip searching for it altogether. In addition, the basic characteristics of RSS feeds allow users to be updated or informed of critical, real-time information as it becomes available. Advantageously, because the content coming from an RSS feed is controlled by the source, there is inherently a level assurance that the content can be trusted. The application of a technology such as an RSS feed could greatly benefit the delivery of general content, advertisements and notifications from Internet based businesses. However, there is a need in the art for a mechanism to provide feedback regarding customer utilization of the RSS feeds. What is needed is a solution that provides an increased level of feedback for RSS feeds in conjunction with a high degree of granularity regarding the applicability of the feedback.

### BRIEF SUMMARY OF THE INVENTION

The present invention addresses the above described needs in the art by providing a technique to gather and report metrics pertaining to an RSS feed.

One aspect of the present invention includes utilizing feedback hooks, such as web beacons to obtain and report activity pertaining to an RSS feed. The web beacons can be placed into the various fields of the RSS index file entries and/or within the RSS content files. In operation, when the various components of the RSS feed are accessed, the web beacons report such activity to a reporting system. With the use of individualized RSS feeds, the information reported can be user specific.

Another aspect of the present invention includes utilizing redirection with links associated with the RSS feed. For instance, the links that are used to access the content files, as well as links within the content files can be redirected to a reporting system rather than the original destination. When the RSS content files are created, these original links can be identified and modified to point to the reporting system and include parameters to identify the original destination. When the links are actuated, the reporting system gathers and records pertinent information such as who, when and where the link was accessed, and then redirects the actuator to the original destination.

Another aspect of the present invention is the ability to measure conversion. The conversion can be measured by (a) using a redirect link with conversion specific information in the link's parameters (e.g., product type, etc) and (b) a JavaScript which executes on a web page. Typically the web page provides a “thank you for ordering X”. This JavaScript calls back to the measurement system and sends the conversion (purchase, sign up, etc) information.

Another aspect of the present invention is provide RSS feed level feedback. This can be performed by the RSS catcher or by a server housing the RSS feed. As the RSS feed is created, subscribed to, activated, accessed, canceled, etc., this information can be provided to a reporting system.

Another aspect of the present invention is the use of individualized or personalized RSS feeds and the provision of feedback pertaining to the same. By providing such feedback, the content sources cannot only obtain general information about an RSS feed and the content but can actually obtain user level feedback information.

### BRIEF DESCRIPTION OF THE SEVERAL VIEWS OF THE DRAWING

FIG. 1 is a functional block diagram illustrating two mechanisms for obtaining feedback in an RSS feed.

FIG. 2 is a functional block diagram illustrating the metric measurements during an opting in activity.

FIG. 3 is a functional block diagram illustrating some of the operations and reporting events available during message creation.

### DETAILED DESCRIPTION OF THE INVENTION

The present invention is directed towards obtain feedback metrics and usage information pertaining to a personalized RSS feed. More specifically, the present invention is directed towards creating a personalized RSS feed through the use of an RSS catcher that is operable to convert content into RSS feeds and to obtain information regarding the provision and access of the RSS feed to a reporting system.

Now turning to the drawings in which like labels and numbers refer to like elements throughout the several views, various embodiments and aspects of the present invention are described more fully.

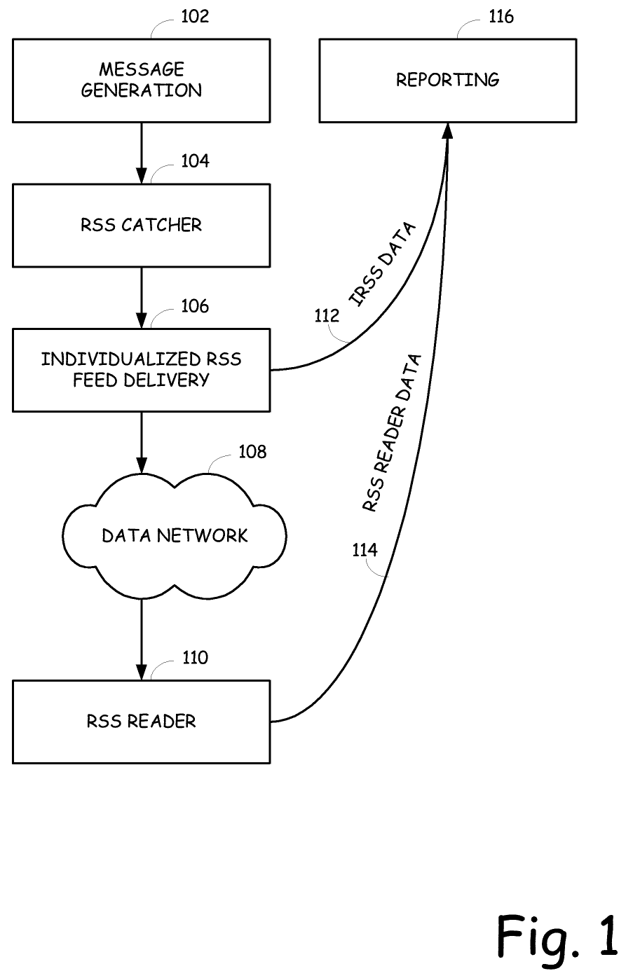

FIG. 1 is a functional block diagram illustrating two mechanisms for obtaining feedback in an RSS feed. Messages are generated by a content source 102 as more thoroughly described in the incorporated applications. However, various sources such as high-volume email systems, weblog content systems (popularly known as “blogs”), news article generation systems, news letter generators, or the like operate to generate content for the RSS feed. The messages are then received by an RSS catcher 104. The RSS catcher, as more fully described in the incorporated applications, operates to convert the messages from the content source into a personalized RSS feed as more fully described in the United States patent applications incorporated herein by reference.

In general, the United States patent applications incorporated by reference disclose an RSS catcher that operates to receive information from a variety of sources, and then makes the information available to various customers through an individualized RSS feed for each customer. Thus, broadcasted information, such as information provided through a high-volume email system can be captured and converted into an RSS feed available for the general public. In addition, broadcasted information provided through a high-volume email system can be converted into a personalized RSS feed available for specific and intended customers. The employment of an RSS catcher allows for the delivery of high-volume electronic messaging without the vulnerabilities that plague high-volume email technology. In addition, the RSS catcher technology operates to enable phishing free pushing of notifications to customers. Thus, the RSS catcher provides, among other things, a general RSS catcher that includes a system that can be retrofitted into existing email marketing solutions or any system that organizes and facilitates the sending of email. As a result, any email generating system, or content generating system, can be turned into a personalized RSS feed system.

The RSS catcher also allows for the controlled delivery of content to a user wherein content items directed towards an address identifier are received. For each such content item, it is determined if an RSS feed has already been created for the intended recipient. If content items that include the address identifier have been previously received, then an RSS feed is created with the URL for accessing the RSS feed including a unique identifier that is generated using at least the address identifier. Portions of the content of the content item is then used to create an entry in a main RSS based file (the XML index file) while other portions may be placed into a separate HTML or XML based file that can be linked to from the main XML indexed file. If content items have been previously received for that address identifier, the URL associated with the identifier is determined and the XML index file addressable with the URL is modified to include an entry for the content item. Thus, a unique RSS feed is created for each uniquely addressed content item. For email messages, this would create a unique RSS feed for each uniquely addressed email.

The RSS feed is available through a data network 108, such as the Internet, by using an RSS reader 110. Two paths are available for obtaining feedback pertaining the RSS feed and the recipient's use thereof: a path from the individualized RSS feed (IRSS Data 112) and a path from the RSS reader (RSS Reader Data 114). These paths provide various feedback data to a report generator or other reporting mechanism 116. Thus, the present invention shows two feedback stages, the feed delivery and the RSS reader actions. Both of these feedback stages provide data back to the reporting system.

Several metrics pertaining to RSS feeds can be obtained. Some of these metrics include: (a) information regarding a user opting in to a feed, (b) activation of a feed, (c) message creation, (d) accessing the RSS summary or description of a message or article, (e) clicking to view a message or article, (f) reading a message or article, (g) clicking on a link within the message or article and (h) conversion (conversion is a marketing term that means a desired action has occurred like purchasing something or signing up for a seminar). Each of these metrics are further described below but it will be appreciated that other metrics could also be identified by those skilled in the art and could be incorporated into the present invention.

Several kinds of information can be obtained and stored for the various metrics and then stored or used for reporting and analysis. These kinds of information include: (1) the type of event that has occurred, (2) the date and time of the event, (3) The IP address of the recipient's computer or server that triggered the event, (4) if the content is secure, confidential or password protected, the username or account ID of the person triggering the event, (5) the number of times the event occurred across all recipient of that message, and (6) the number of times the event occurred for each individual recipient. It will be appreciated by those skilled in the art that additional kinds of information could be obtained regarding the RSS feed and that the information listed here is simply provided as a non-limiting example, although in and of itself, such information is considered novel.

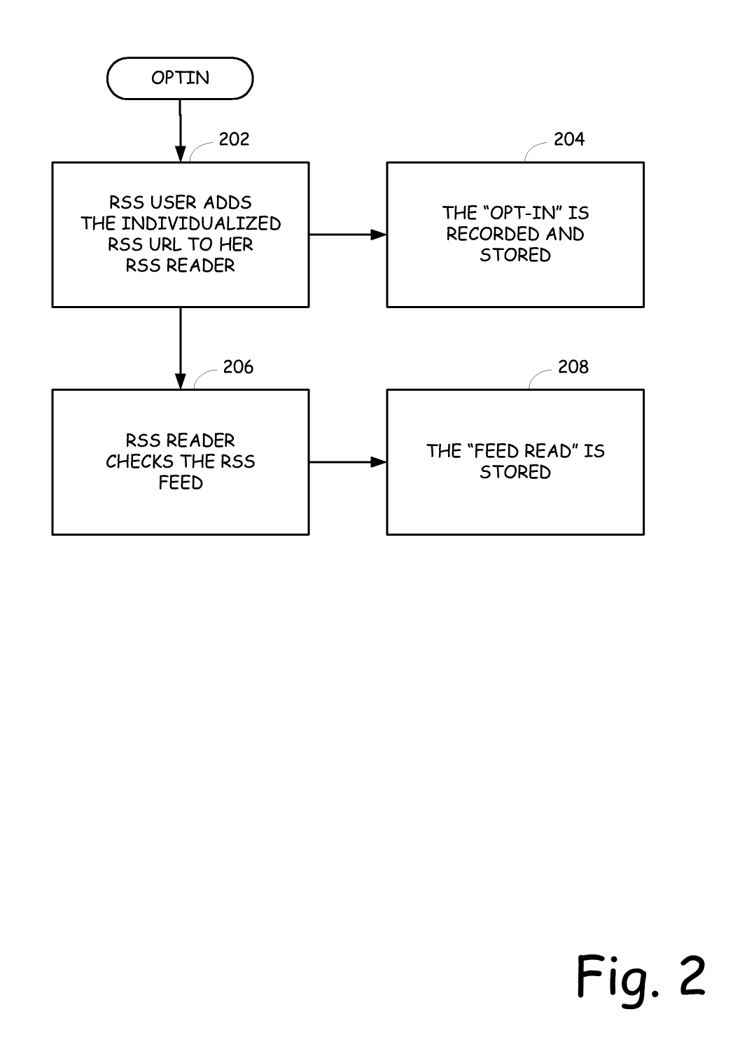

FIG. 2 is a functional block diagram illustrating the metric measurements during an opting in activity. At the time an IRSS feed is created, several things can happen. The user performs an opt-in (also known as a subscription) event when the user adds the URL of a personalized or individualized RSS feed into his or her RSS reader 202. This opt-in event is recorded and stored 204. The RSS reader than checks the RSS feed 206. The event of the RSS reader checking the RSS feed is recorded and stored 208. Thus, the reporting system obtains information pertaining to a new feed being registered in the system and the total number of individuals subscribing to that feed can be incremented. This information can then be stored for future reporting.

The creation of a feed and the actual RSS reader checking the feed are two separate events. Simply because a feed has been created, does not necessarily mean that the user will tell their RSS reader to check the feed. Thus, the checking of the feed is a separately trackable event. This occurs when a user's RSS reader checks the feed 206. This event can be detected and stored 208.

RSS feeds are generally checked no more often than an hour and no less often than a day. Using a configurable threshold (e.g., the longest time since a feed was checked), the system can report on the number of active feeds.

In Individualized RSS systems like the one mentioned in the herein referenced patents, each RSS feed is unique for each subscriber/recipient. As a result, every RSS feed is checked individually. Advantageously, this allows for a more accurate view of active feeds (or active subscribers) than solutions based on broadcast RSS (where one feed supplies all users) because systems like YAHOO! read the feed once for every user (YAHOO caches it). So, without individual feeds, systems like YAHOO! will cause broadcast RSS active subscriber counts to look lower than they are in actuality.

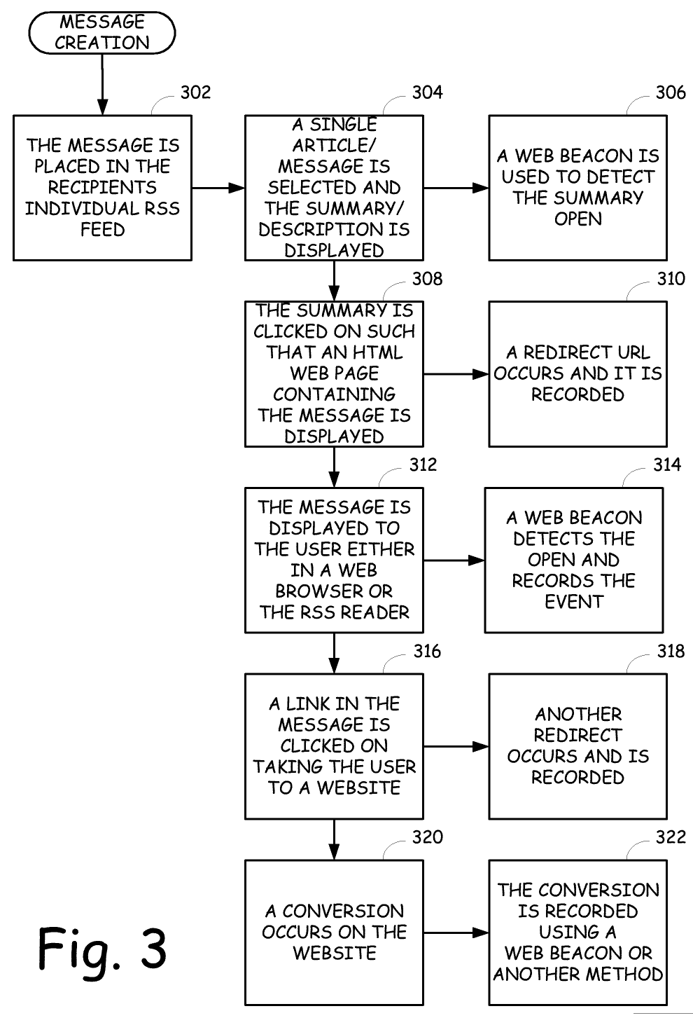

FIG. 3 is a functional block diagram illustrating some of the operations and reporting events available during message creation. Each time a message is created and interjected into the RSS feed, every recipient subscribing to the RSS feed gets a uniquely generated message 302. In addition to recipient-readable unique information such as the name or account number, several internal unique identifiers are created for the purpose of obtaining and maintaining metric measurements. These internal unique identifiers include (a) summary open web beacon, (b) message view redirect, (c) message open web beacon, (d) a click through redirect for each link in the message and (e) conversion link/JavaScript.

More specifically, at step 304, a single article or message is selected and the summary description is displayed. One aspect of the present invention is to utilize feedback hooks within an RSS file to obtain feedback information. Such a feedback hook includes, but is not limited to a web beacon which, in cooperation with the uniqueness of the personalized feed, enables the attainment of user specific metrics pertaining to accessing a message, as well as global metrics. A web beacon is used to detect and record the opening of the summary 306. A web beacon is an often-transparent graphic image that is placed on a site (or in an e-mail or content item) and when used in combination with unique ID's for each user, can monitor the behavior of the user visiting the site (or sending the e-mail or the RSS content). The web beacon may be a small graphic, either a 1-pixel hidden image or a uniquely coded header/footer graphic. The type of information collected might include the Internet Protocol address of the computer that retrieved the image, the time the web beacon was viewed, and the type of browser that retrieved the image.

Thus, when a user sees a list of RSS messages (or articles) provided them from an RSS feed and displayed in their RSS reader, they can click on one to read the summary of that message. The web beacon within the message is coded in a way that is unique to each recipient. Methods of coding vary but they include a unique name (e.g., Citibank-header-12308812A.jpg) or with a parameter (e.g., Citibank-header.jpg/uid=12308812A).

Whenever the web servers that provide these graphics deliver the image, the delivery is recorded and stored. The unique coding allows the measurement and reporting system to know which specific recipient saw the message summary.

It will be appreciated that not all RSS readers display summaries. Other readers may display a short version of the summary but remove any images from the summary. Therefore, the summary read measurement will always be imprecise on such implementations.

Another aspect of the present invention is to obtain metric information through utilizing redirection. When the summary is displayed, the RSS readers allows a user to click somewhere in the summary to see the full message 308. When the original message is created, a special link or interim link is created that is unique to each individual recipient. This link points back to the measurement system (rather than the HTML file that contains the message). The measurement system receives the link, records/stores it and then redirects the browser back to the proper HTML file or the original link containing the message 310. From the user perspective, this redirect is instantaneous and undetectable. However, advantageously by passing through the measurement system, the activity can be recorded and used to show the senders that a full message view was requested. A non-limiting example of a redirect link may be as follows: http://www.sendingengine.com/links/msg=1234&uid=12308812A.

When the message file is selected, it is displayed to the user 312. A message read event can be detected and recorded by placing a unique web beacon, similar to the one included in the summary, into the message file. This beacon (or other image) will contain unique coding that can be used to notify the sender that the message was displayed and which recipient actually saw the message 314.

Typically, a message file may contain one or more additional links to other files or websites. This is typical in an advertisement that allows the reader to access additional information about a product, or a newsletter that allows the user to access additional information about the article. Other examples will come to the mind of the reader and these examples are provided as non-limiting examples. Another aspect of the present invention is to obtain and record metrics pertaining to accessing these links within a message file. When the message file is created, a unique redirect click is created for every link within the message. When any link in the displayed message file is clicked 316, the measurement system can detect this and store it for later reporting 318. It should be appreciated that the summary may also contain links that are also measurable using this redirect method.

The goal of many messages is create an action by the recipient. As non-limiting examples, that action may include purchasing something or signing up for a seminar or a newsletter. Such actions are termed conversion. Conversion can be detected in a variety of manners recorded for later measurement purposes. Similar to all the events above, conversion can also be uniquely coded such that the specific conversion can be associated with a specific recipient. Thus, when a user performs an action that results in a conversion 320, a web beacon or other mechanism can record the individualized action and store it for reporting 322. Marketers can append additional information to conversions so that later measurements include specific products purchased or other detailed information.

Once the above events are recorded and stored, they can be used to provide a wide variety of reports that assist senders and content providers in making their communications more relevant and interesting to the recipients. Examples of information that can be included within the reports includes, but is not limited to, the following information:

Total number of opens or clicks for a content item, including the summary, the message, or links within the message;

Number of recipients who clicked or opened a content item;

Percentage of recipients that opened a message and then clicked on something within the message;

Average number of clicks within a message that resulted in a conversion;

Average number of recipients who saw a summary and clicked to view the whole message;

Percentage of recipients who are checking their feeds relative to the number who opted in; and

Percentage of recipients that are opening summaries relative to the number checking their feeds.

Thus, the present invention provides mechanism, techniques and solutions to allow for the collection of metrics and analytics pertaining to Individualized RSS feed activity. By augmenting the files within an RSS feed and augmenting the RSS reader, the metrics can be obtained and used to generate valuable activity reports.

While the foregoing specification illustrates and describes the various embodiments and aspects of this invention, it is to be understood that the invention is not limited to the precise construction herein disclosed. The invention can be embodied in other specific forms without departing from the spirit or essential attributes. In addition, various aspects of the present invention have been described. Not all of the aspects are required to gain novelty and various embodiments may utilize on a subset of the various aspects. Accordingly, reference should be made to the following claims, rather than to the foregoing specification, as indicating the scope of the invention.

What is claimed is:

1. A method for providing action feedback for RSS feeds, the method comprising the steps of
receiving a content item from a content source that is operable to send pushed content items directed towards a user through the use of an address identifier for each content item;
based at least in part on at least a portion of the address identifier for the pushed content item, generating a substantially unique identifier;
creating an individualized RSS index file having a URL that is based at least in part on the substantially unique identifier and that contains the received pushed content;
placing an entry into the individualized RSS index file that includes a summary of the content item and a link to an RSS content file containing a substantial portion of the content item; and
placing feedback hooks into the individualized RSS index file for obtaining action feedback.

2. The method of claim 1, wherein the step of placing a feedback hook into the individualized RSS index file further comprises, placing a web beacon within the summary of the entry in the RSS index file.

3. The method of claim 1, further comprising the step of placing feedback hooks into the RSS content file.

4. The method of claim 3, wherein the step of placing feedback hooks into the RSS content file further comprises placing a web beacon within the RSS content file.

5. The method of claim 3, wherein the step of placing feedback hooks into the RSS content file, further comprises the steps of:
creating interim links within the RSS content file for one or more original links, each interim link pointing to a measurement system, the original link pointing to an actual XML file;
receiving the actuation from an actuator of an interim link at the measurement system;
recording the action;
redirecting the actuator to the proper XML file associated with the original link.

6. The method of claim 1, wherein the system housing the individualized RSS index file provides activity reports to a reporting system regarding the creation of the individualized RSS index file, subscription to the individualized RSS index file and/or activation of the individualized RSS index file.

7. A system that provides activity feedback for RSS feeds, the system comprising:
a content source that is operable to send content items directed towards a user through the use of an address identifier for each content item;
a content catcher that is operable to:
receive a content item;
identify the address identifier;
based at least in part on at least a portion of the address identifier for the pushed content item, generating a substantially unique identifier;
creating an RSS index file having a URL that is based at least in part on the substantially unique identifier and that contains the modified content item;
creating an entry with the RSS index file, the entry including a summary of the content item and a link to an RSS content file containing a substantial portion of the content item;
placing a feedback hook within the entry.

8. The system of claim 7, wherein the content catcher is operable to place a feedback hook within the entry by included a web beacon within the entry.

9. The system of claim 7, wherein the content catcher is operable to place one or more feedback hooks within the RSS content file.

10. The system of claim 9, wherein the one or more feedback hooks within the RSS content file are web beacons.

11. The system of claim 9, wherein the one or more feedback hooks within the RSS content file are interim links that replace original links and results in redirecting actuators of the links to a measurement system that records the action and the redirects the actuator to the original link.

12. An RSS catcher that facilitates the provision of feedback pertaining to activity associated with an RSS feed, the RSS being operable to:
receive a content item from a content source;
creating an RSS index file having a URL that is used to access the RSS index file;
creating an RSS content file and placing a substantial portion of the content item within the RSS content file;
creating an entry with the RSS index file, the entry including a summary of the content item and a link to an RSS content file;
placing a feedback hook within the entry.

13. The RSS catcher of claim 12, wherein the content catcher is operable to place a feedback hook within the entry by included a web beacon within the entry.

14. The RSS catcher of claim 12, wherein the content catcher is operable to place one or more feedback hooks within the RSS content file.

15. The RSS catcher of claim 14, wherein the one or more feedback hooks within the RSS content file are web beacons.

16. The RSS catcher of claim 14, wherein the one or more feedback hooks within the RSS content file are interim links that replace original links and results in redirecting actuators of the links to a measurement system that records the action and the redirects the actuator to the original link.

17. The RSS catcher of claim 12, wherein the RSS catcher is further operative to send information regarding the creation, subscription and access of the RSS index file and RSS content file to a reporting system.

18. The RSS catcher of claim 12, wherein the content item includes an address identifier and the URL of the RSS index file is a unique value based at least in part on the address identifier.

19. The RSS catcher of claim 18, wherein the content catcher is operable to place one or more interim links in the RSS content file that replace original links and results in redirecting actuators of the links to a measurement system that records the action and the redirects the actuator to the original link, the interim links being unique based on the individualized RSS index file.

20. The RSS catcher of claim 19, wherein at least one of the links operates as a conversion.
